(19) United States
(12) Patent Application Publication
(10) Pub. No.: US 2026/0299281 A1
(43) Pub. Date: Oct. 1, 2026

(54) Changer for Optical Elements and Optical Instrument

(71) Applicant: ATMOS MedizinTechnik GmbH & Co. KG, Lenzkirch (DE)

(72) Inventors: Björn BOYSEN, Lenzkirch (DE); Carsten REINHARDT, Lenzkirch (DE)

(73) Assignee: ATMOS MedizinTechnik GmbH & Co. KG, Lenzkirch (DE)

(21) Appl. No.: 19/271,196

(22) Filed: Jul. 16, 2025

(30) Foreign Application Priority Data
Jul. 19, 2024 (EP) 241898139

(51) Int. Cl. G02B 26/00; G02B 7/00; G02B 27/02

(52) U.S. Cl. CPC G02B 26/00; G02B 7/005; G02B 27/024

(57) ABSTRACT

Provided are a changer for optical elements of an optical instrument [sic: and an optical instrument], wherein the optical instrument comprises at least one viewing channel and at least one illumination channel, wherein the changer comprises a first carrier for optical elements which is supported rotatably about a center axis and further comprises a second carrier for optical elements which is supported rotatably about the same center axis as the first carrier, wherein on the first carrier a number M of optical elements for influencing light in the viewing channel or in the illumination channel comprises [sic: is disposed] which comprises a set of M1 sequentially disposed optical elements with which onto the light in the viewing channel or in the illumination channel, M1 different properties can be impressed, wherein on the second carrier a number N of optical elements for influencing light comprises [sic: is disposed for influencing light] in the illumination channel or in the viewing channel which comprises a set of N1 sequentially disposed optical elements with which onto the light in the illumination channel or in the viewing channel N1 different properties can be impressed, wherein the optical elements disposed on the first carrier for optical elements are each disposed at a first distance from the center axis such that the distance between the adjacently disposed optical elements, at least for the M1 sequentially disposed elements, is equal, wherein the optical elements disposed on the second carrier for optical elements are each disposed at a second distance from the center axis such that the distance between these adjacently disposed optical elements, at least for the N1 sequentially disposed elements, is equal, wherein the second distance is greater than the first distance, wherein the first carrier (110) and the second carrier (120) are implemented such that they comprise openings or transparent regions for enabling the passage of light at the sites which are located in front or behind an optical element of the particular other carrier when both optical elements are introduced effectively into the particular viewing ot illumination channel, and an optical instrument with such a changer.

Changers for optical elements are assemblies utilized in a multiplicity of optical instruments in which certain properties of the light or a portion of the lightpath in an illumination channel and/or in a viewing channel can be specifically changed, such as the frequency using colour filters, the polarization using polarization filters or the beam path using apertures, gratings or lenses. Further alternatives are reticles which can be inserted into the illumination channel or the viewing channel. In principle, reticles do not change the property of the transmitted light but only a small portion of the beam path which ensures the display of the patterns contained on the reticles.

It should be stated at this point that within the scope of this disclosure, that a viewing channel can be designed both for visual viewing as well as for viewing by means of a recording medium, such as, for example, a CCD or a CMOS camera.

A widely employed manner in prior art of configuring such changers for optical elements comprises disposing the desired set of optical elements on a carrier which is rotatable about a center axis such that the optical elements are disposed at equal distances from the center axis.

This center axis is subsequently situated at this distance from the illumination and/or viewing channel of the optical instrument such that by rotating the carrier the different optical elements of the set of optical elements can be moved into the beam path of the illumination and/or viewing channel.

There is also the option that channels are utilized for illumination as well as also for viewing, for example if the illumination is coupled via beam splitter into the viewing beam entry. The other channels can subsequently be utilized for additional illumination of different wavelengths or for polarization.

The distance between adjacent optical elements of the carrier is herein preferably equal such that changing from one of the optical elements of the carrier to the optical element adjacent to it in each instance takes place by rotation about the same angle.

If the optical instrument comprises two similar illumination or viewing channels, such as is the case, for example, in a stereo microscope or exoscope, and if onto them through the optical elements of the changer the same optical properties are to be impressed or fixed combinations of optical properties are to be impressed by the optical elements of the changer, this is feasible with the above described configuration thereby that the axis of the optical changer is disposed on a connecting line between the similar illumination or viewing channels such that optical elements disposed opposite to one another are each moved simultaneously into the beam entry of the two similar illumination or viewing channels. The multiplicity of different settable states can then be increased thereby that several such changers for optical elements are disposed sequentially on the same axis. DE 10 2009 011 681 A1 or DE 10 2020 100 676B3, for example, disclose such configurations which can be realized relatively compactly.

Alternatively, a greater multiplicity of combinations of state can be realized thereby that each of the two similar illumination or viewing channels is equipped with its own changer for optical elements, such as is proposed, for example in DE 103 36 890A1. However, this leads naturally, on the one hand, to a considerable increase of the required installation space and, on the other hand, to greater expenditures since the relevant changer must also be actuated separately.

The situation becomes even more complex and costly when there are viewing as well as also illumination channels for each of which specific optical properties are to be defined with one changer for optical elements. An example of such a system with three changers actuatable independently of one another for optical elements can be found in DE 10 2006 004 232A1.

The invention therefore addresses the problem of providing a compact and cost-effective changer for optical elements with which optical properties of at least one illumination channel and at least one viewing channel can be varied independently of one another and an optical instrument with such a changer for optical elements.

This problem is resolved by a changer for optical elements with the characteristics of patent claim 1 and an optical instrument with the characteristics of patent claim 9. Advantageous further developments of the invention are subject matter of the particular dependent claims.

The changer according to the invention for optical elements changes optical elements of an optical instrument which comprises at least one viewing channel and at least one illumination channel.

The changer according to the invention comprises a first carrier for optical elements which is supported rotatably about a center axis and, further, a second carrier for optical elements which is supported rotatably about the same center axis as the first carrier.

On the first carrier is disposed a number M of optical elements for influencing light in the viewing channel or in the illumination channel, comprising a set of M1 sequentially disposed optical elements with which onto the light in the viewing channel or in the illumination channel M1 different properties can be impressed; on the second carrier is disposed N number of optical elements for influencing the light in the illumination channel or in the viewing channel, which comprises a set of N1 sequentially disposed optical elements with which onto the light in the illumination channel or in the viewing channel N1 different properties can be impressed. The term “sequentially disposed” is to express that N1 or M1 optical elements for influencing light that passes through them disposed on the particular carrier such that they follow one another in a given sequence, impress onto the light which passes through them N1 or M1 different optical properties.

When the first carrier and the second carrier can be moved independently of one another by a drive associated with the particular carrier and when in each case precisely one viewing and one illumination channel are available, N can equal N1 and M can equal M1. However, in most embodiments of the invention N>N1 and M>M1.

It should here be explicitly pointed out that there are also embodiments of the invention in which several illumination or several viewing channels are provided into which different sets of optical elements are introduced. Stated differently, it is neither absolutely required that each optical element on a given carrier can be introduced into each illumination or viewing channel nor is it absolutely required that at a given point in time into all illumination channels or into all viewing channels optical elements have been introduced which impress the same optical properties.

The optical elements disposed on the first carrier for optical elements are each disposed at a first distance R1 from the center axis such that the distance between these optical elements adjacent to one another, at least of the M1 sequentially disposed optical elements, is equal which is fulfilled in particular when for the conveyance of a given optical element into the position of the next or previous optical element of the set of sequentially disposed optical elements can in each case be accomplished through a rotation about the same angle.

The optical elements disposed on the second carrier for optical elements are each disposed at a second distance R2 from the center axis such that the distance between adjacent optical elements with respect to one another, at least of the N1 sequentially disposed optical elements, is equal which here also is in particular fulfilled if the conveyance of a given optical element into the position of the next or previous optical element of the set of sequentially disposed optical elements can be accomplished each time by a rotation about the same angle (which, however, can be a different angle than in the case of the first carrier). The second distance R2 can herein be greater than the first distance R1.

The significance of the restriction “at least for the N1 or M1 sequentially disposed elements” arises therefrom that it can be useful, in particular in the case of changers that are intended for use in optical instruments that comprise two illumination channels and two viewing channels each of which utilizes light with the same or different properties for the illumination and with the same or different properties for viewing, to provide for each illumination or viewing channel a set of N1 or M1 sequentially disposed optical elements, wherein in this case optionally the distance between optical elements belonging to the set of different illumination or viewing channels, can be greater than the distance between optical elements belonging to the set of the same illumination or viewing channel. Herein the N1 or M1 sequentially disposed optical elements of the first illumination channel or viewing channel and the N1 or M1 of sequentially disposed optical elements of the second illumination or viewing channel can also differ from one another with respect to optical properties.

This disposition of the particular optical elements on the particular carriers ensures that they are substantially located on a circular track and/or by a rotation of the particular carrier, which for a given carrier is always of same magnitude, however, as a rule, differs for different carriers, can be changed from one optical element to the adjacent optical element. Distances R1 and R2 are herein selected such that, if the changer is employed in an optical instrument, the optical elements are introduced into the at least one viewing or the at least one illumination channel. Whether the first carrier with the optical elements disposed thereon is herein associated with the at least one illumination channel and the second carrier is associated with the optical elements disposed thereon with the at least one viewing channel or conversely depends on the geometry of the disposition of these channels in the optical instrument.

Further, the first carrier and the second carrier are implemented such that they do not block the light passage at the sites located in front or behind an optical element of the, in each case, other carrier when both optical elements are effectively introduced into the particular viewing or illuminating channel, which is in particular the case if they are transparent or include an opening at these sites. When this must be given depends on the geometry of the disposition of viewing or illumination channels in the particular optical instrument.

If illumination and viewing channels are, for example, disposed next to one another on the same radius, thus on the same line starting from a central axis of the optical instrument, this must be the case if this optical element of the first carrier and an optical element of the second carrier are oriented in a line starting at the center axis. At the site located in front or behind the optical element of the first carrier the second carrier then comprises an opening or is transparent. The first carrier should then be implemented in such a way that, when an optical element of the first carrier and an optical element of the second carrier are aligned in a line extending from the center line, it is surmounted by this optical element or comprises at the site in front of or behind which this optical element of the second carrier is disposed, an opening or a transparent region is disposed at this site

If, however, illumination and viewing channels are offset by an angle (for example of 90° as in the embodiment example discussed below) this condition must be fulfilled when the two carriers are set relatively with respect to one another such that this angle between the connection lines between the center axis and the particular optical elements is given.

This condition assures that none of the carriers blocks the passage of light through the optical elements of the particular other carrier. Within the meaning of this disclosure by opening in the carrier is also to be understood the free space that exists between the arms or rays of a star-shaped carrier or a region in which the other carrier completely surmounts this carrier. Especially simple is an implementation of the first carrier as a disk and of the second carrier as a circular ring encompassing the disk or as a star-shaped structure in which the rays of the star run between adjacent optical elements disposed on the first carrier such that rays of light which pass through the elements disposed on the first carrier run through gaps between the rays of the star.

The changer for optical elements as intended is installed in an optical instrument such that its rotational axis extends parallel to the illumination and viewing channel and that its rotational axis is located, on one hand, at a distance R1 from the center point of that channel that is closer to the rotational axis and simultaneously is located at a distance R2 from the center point of that channel which extends further away from the rotational axis.

The condition that both optical elements have effectively been introduced into the particular viewing or illumination channel, in such an installation condition is always fulfilled when the optical element of the first carrier and the optical element of the second carrier have been rotated into the particular illumination or viewing channel and in each instance impress onto the light corresponding properties. Of course, in this position they must not be obscured by the carrier of the optical elements for influencing the properties of the light in the other channel, which is ensured by the transparent sites or openings of the carrier at corresponding positions.

A highly compact disposition of the optical elements is ensured by disposing the particular optical elements in each case on a particular circular path on separate carriers which are rotatable about the same axis and geometrically implemented such that they enable the passage of light through the particular optical element.

In a preferred further development of the invention at an angle between two adjacent M optical elements of the first carrier, which is of size α, is provided that the N1 optical elements of a set of sequentially disposed optical elements are disposed on the second carrier within an angular range of 2α.

If in such disposition of optical elements the first carrier comprises a driver and the second carrier comprises a receiver which extends at least over an angular range of (N1−1) /N1*2α and into which engages the driver such that the lateral edges of the receiver form each a limit stop for the driver, it can be achieved that the setting of the two carriers independently of one another can be accomplished with a single drive since, after contact is established between driver and edge of the receiver through a rotation of one carrier into one direction, both carriers are rotated in a further rotation into this direction This applies, of course, analogously if the second carrier comprises a driver and the first carrier comprises a receiver which extends at least over an angular range of (N1−1)/N1*2α and into which the driver engages, such that the lateral edges of the receiver form each a limit stop for the driver.

The utilization of the installation space which the optical changer occupies and/or the installation space which the optical changer requires can be improved if N1>M1. Whether or not this condition can be fulfilled, depends whether or not this is compatible with the position of the illumination and viewing channel of the optical instrument to which the changer belongs.

According to an especially preferred embodiment of the invention N is greater than or equal to N1*1.5, wherein the N−1 optical elements which do not belong to the set of N1 sequentially disposed optical elements, are disposed such they continue the set of N−1 optical elements and specifically either on one side or on both sides.

In the case of a unilateral continuation on the side of the first optical element of the set of N1 sequentially disposed optical elements next follows again an optical element with the same optical properties as those of the last element of the set of N1 sequentially disposed optical elements, then follows one with the same optical properties as the next to the last etc., wherein the distance is also the same as the distance between adjacent optical elements of the set of N1 sequentially disposed optical elements.

In the case of a unilateral continuation on the side of the last optical elements of the set of N1 sequentially disposed optical elements there follows as the next optical element again an optical element with the same optical properties as those of the first element of the set of N1 sequentially disposed optical elements, then one with the same optical properties as the second one, etc. wherein the distance is also the same as that between adjacent optical elements of the set of N1 sequentially disposed optical elements.

In the case of a bilateral continuation there is available a unilateral continuation on the side of the first optical element of the set of N1 sequentially disposed optical elements as well as also on the side of the last optical element of the set of N1 sequentially disposed optical elements.

The reason why this may be advantageous lies therein that if only one carrier is actuated by a motor for a rotation about the angle α which places the next optical element of the first carrier into the viewing beam entry or the illumination beam entry, the second carrier must also be rotated about the angle α which, however, “further advances” it by several of the optical elements disposed thereon. By providing further optical elements which continue the set of N1 optical elements, it is ensured that the travelling path which must be traversed after such a “further advance” in order to move the optical changer again into an operating position in which light from the illumination channel and light from the viewing channel can pass through it again, is minimized.

The continuation is herein also feasible and useful with one complete set or several complete sets of N1 sequentially disposed optical elements, in particular if three or more optical elements belong to a set of optical elements disposed sequentially on the first carrier.

It is especially advantageous if N is a whole number multiple of N1 and/or if M is a whole number multiple of M1 such that several complete sets of sequentially disposed optical elements are disposed on the first or the second carrier, respectively, in particular if they continue one after another as described above. This can also contribute to minimizing the traveling paths required for setting given combinations of optical elements for the at least one illumination channel and the at least one viewing channel.

It is herein especially advantageous if N is a whole number multiple of N1 and/or that M is a whole number multiple of M1, since in this case the corresponding optical properties in instruments with two viewing and two illumination channels can be set especially simply and quickly.

The optical instrument according to the invention is distinguished by a changer for optical elements according to the invention.

It is especially preferred for the optical instrument to comprise two viewing channels and two illumination channels and for the center axis to extend centrally between the viewing channels as well as also centrally between the illumination channels such that, on the one hand, oppositely disposed optical elements of the first carrier simultaneously influence the light in the two viewing channels or in the two illumination channels and, on the other hand, oppositely disposed optical elements of the second carrier influence simultaneously the light in the two illumination channels or viewing channels, thus, in each instance influence [the light in] those channels which the optical elements of the first carrier do not influence. In such a configuration, influence can be exerted onto the light in four optical channels with a simply structured highly compact changer.

In another advantageous embodiment of the optical instrument the changer comprises the characteristics of claim 3 or the characteristics of claim 4 and the optical instrument comprises precisely one motor for the actuation of the optical changer. The optical instrument becomes hereby more cost effective and saves installation space since only one motor needs to be accommodated.

In the following the invention will be explained in greater detail in conjunction with Figures that show embodiment examples. Therein depict:

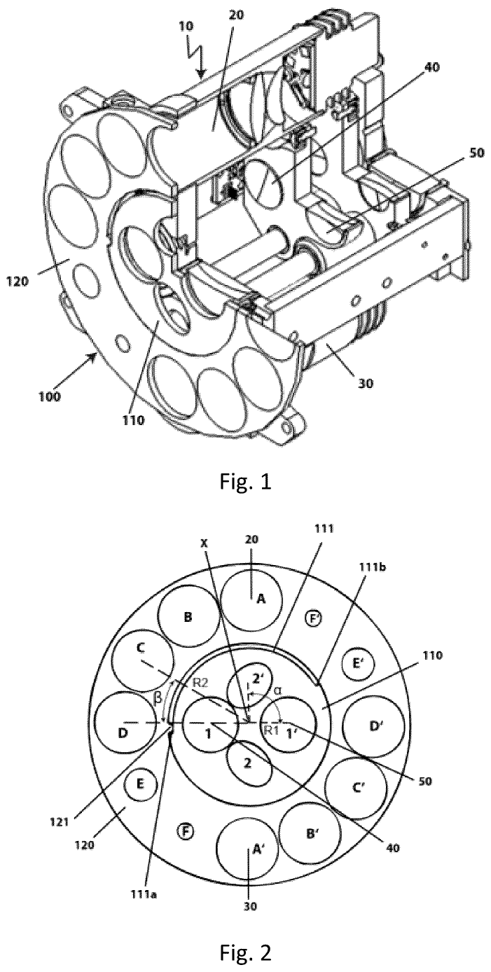

FIG. 1: a component of an optical device with an optical changer in a partially opened representation;

FIG. 2: the optical changer of FIG. 1, viewed from the front and

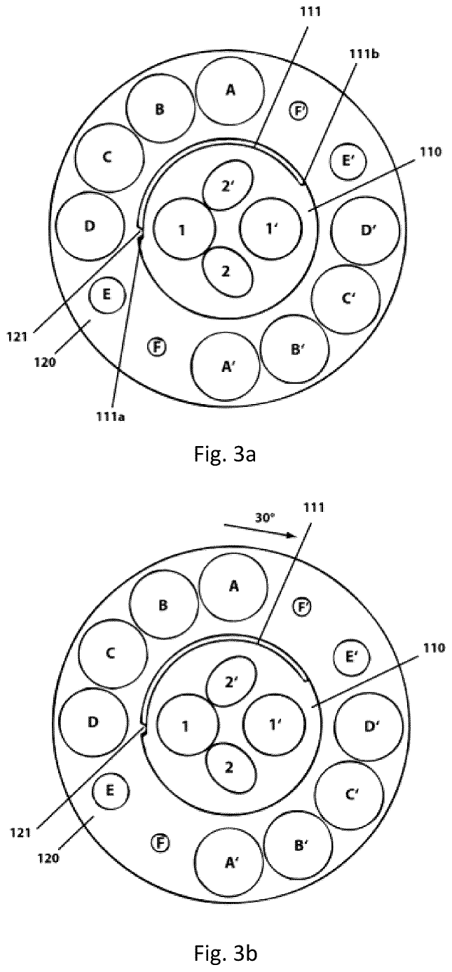

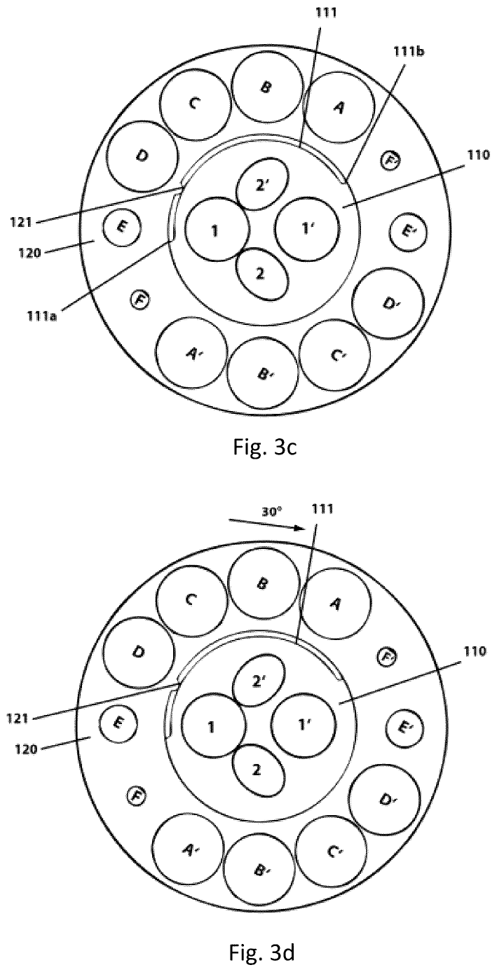

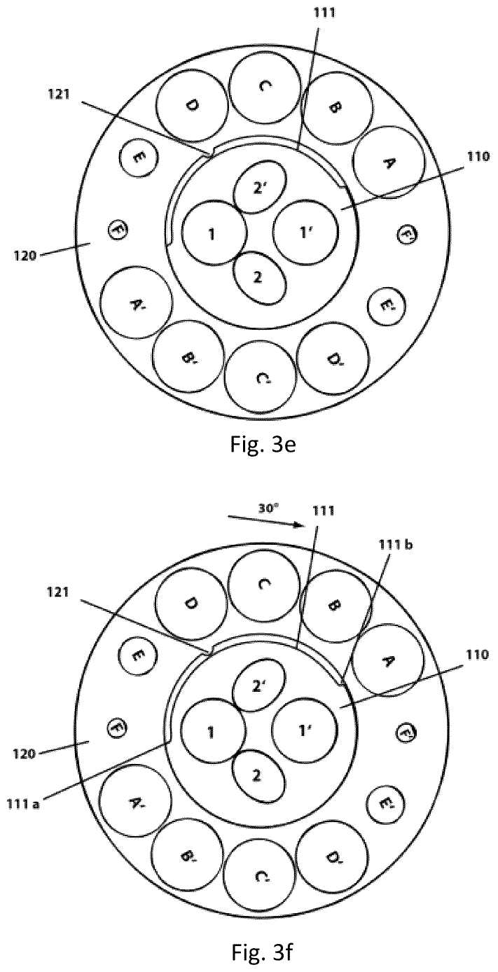

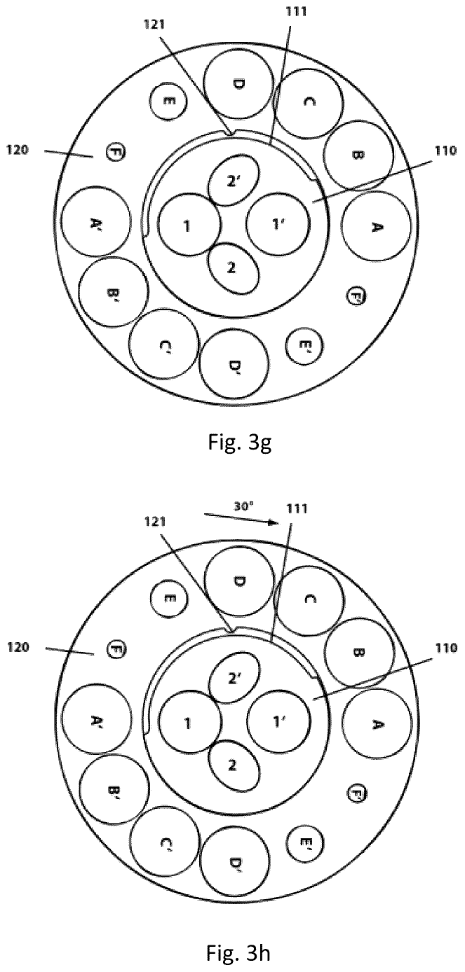

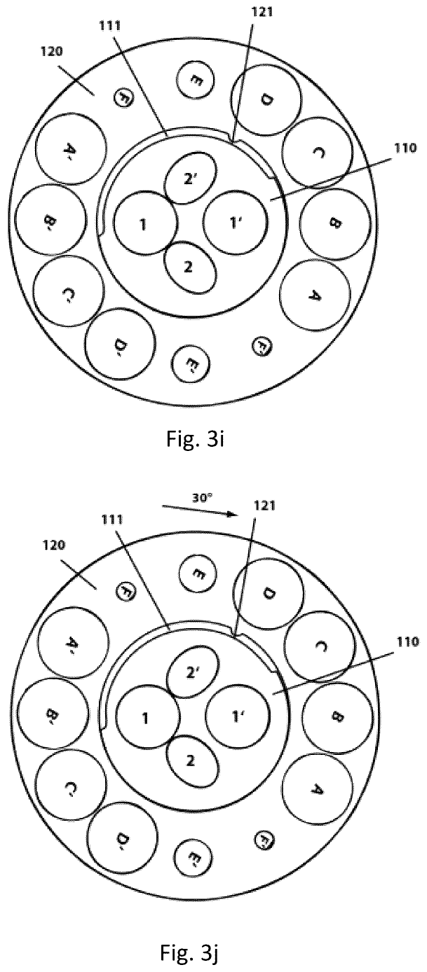

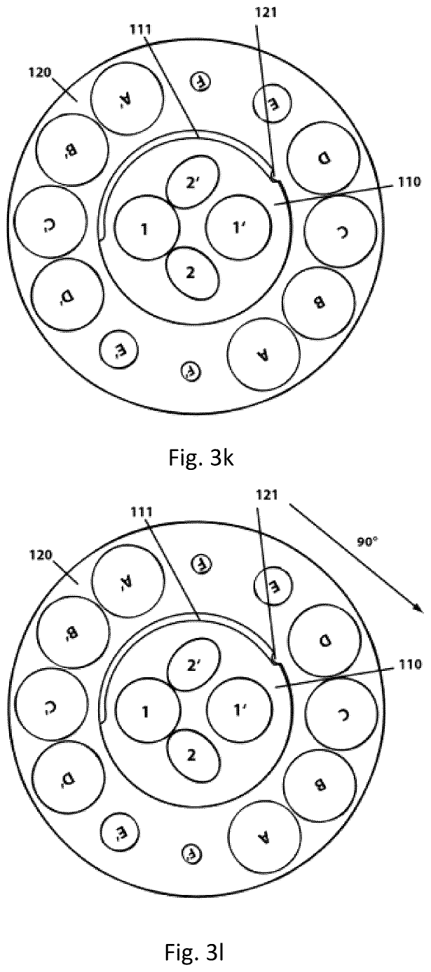

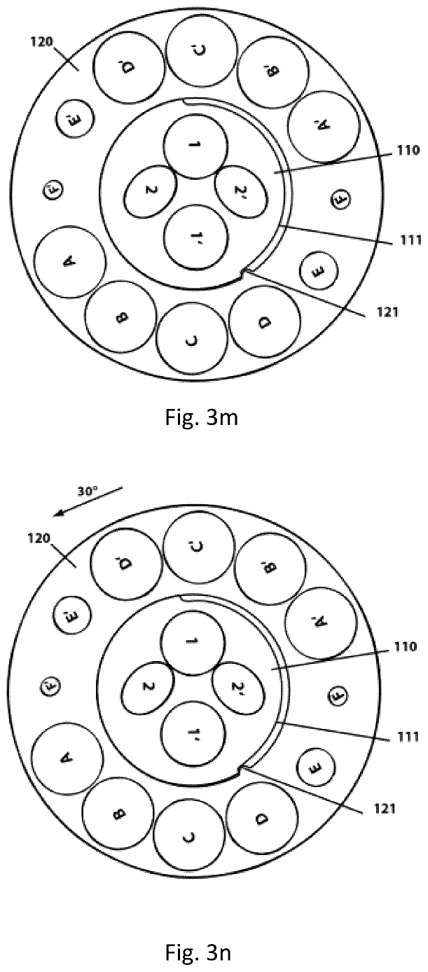

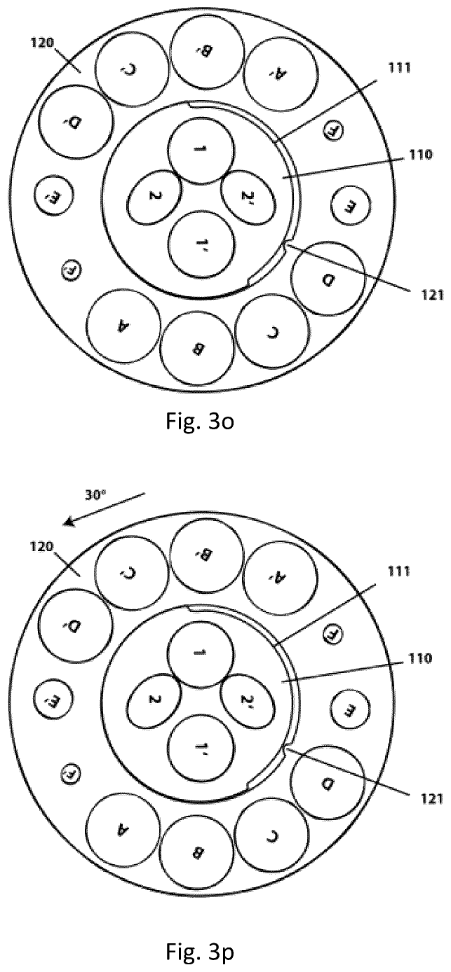

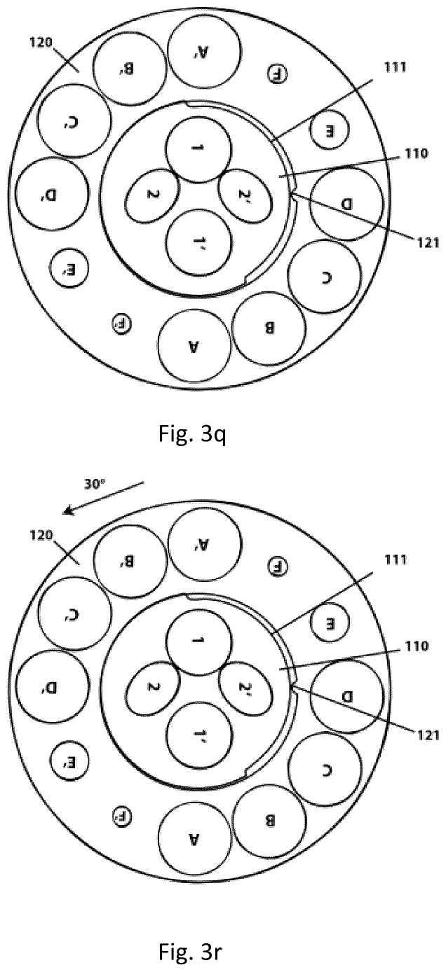

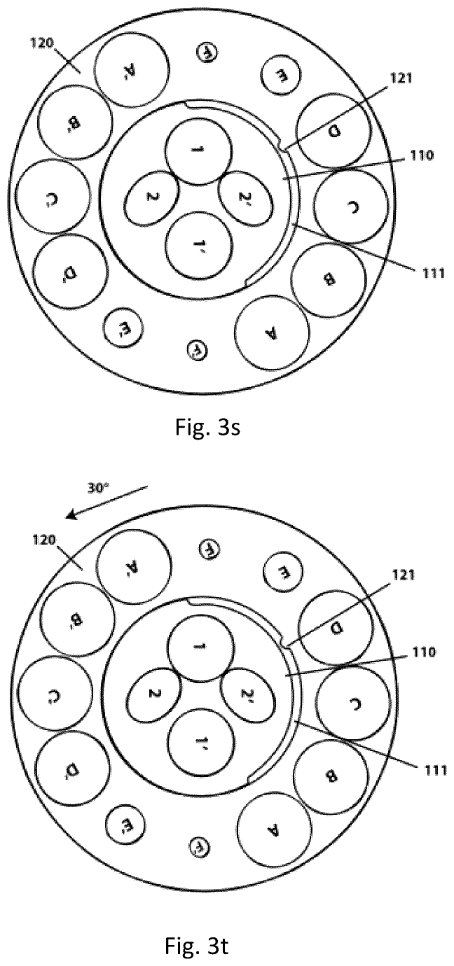

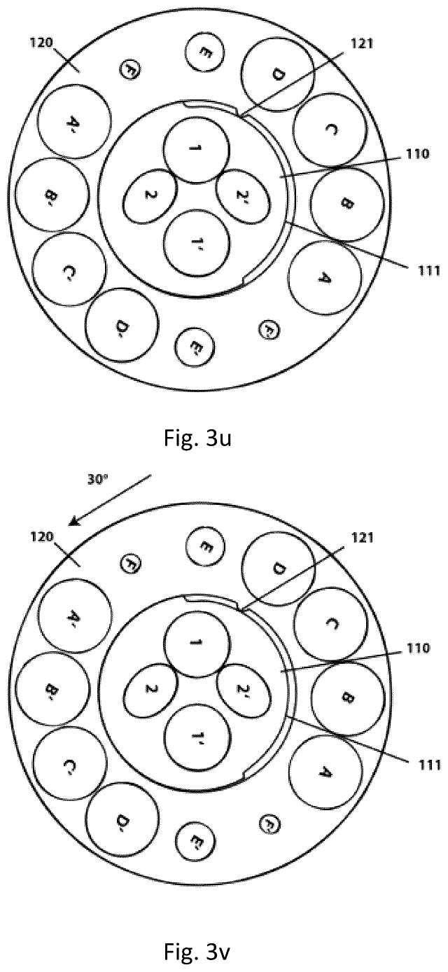

FIG. 3a-3x: the different settings of the optical changer of FIG. 1 and the movements that convey one into the other.

Since the Figures represent the same embodiment of an optical changer 100 the same reference symbols are used in all Figures. However, to improve clarity of vision, not all reference symbols are shown in all Figures.

As can be gathered from FIG. 1, the component of the optical device 10 depicted therein comprises two illumination channels 20, 30 and two viewing channels 40, 50 as well as an optical changer 100.

As can be seen especially well in FIG. 2, the optical changer 100 comprises a first carrier 110 which is disk-shaped and a second carrier 120 which is annular in shape. The first carrier 110 and the second carrier 120 are disposed such that they are rotatable about a common center axis X. This center axis [sic: X] is located at the intersection of an imaginary connection line between the illumination channels 20, 30 and an imaginary connection line between the viewing channels 40, 50, each centrally on the imaginary connection lines such that the center axes of the two illumination channels 20, 30 are each spaced at a distance R2 from the center axis X, and the center axes of the two viewing channels 40, 50 are each spaced at the distance R1 from the center axis X.

On the first carrier 110 are located two sets each of M1=2 sequentially disposed optical elements 1, 2 and 1′, 2′, respectively, which are all disposed at a distance R1 from the center axis X, thus overall M=4 optical elements. The optical properties which the optical elements 1 and 1′ impress onto the light are herein the same. The same applies to the elements 2 and 2′. The distance between a given of the optical elements 1, 1′, 2, 2′ and the particular adjacent optical element 1′, 2, 2′, 1 in each case is identical; accordingly, the angle α between them is also identical and is 90° in each case.

On the second carrier 120 are located two sets of N1=6 sequentially disposed optical elements A, B, C, D, E, F or A′, B′, C′, D′, E′, F′, all of which are disposed at a distance R2 from the center axis [sic: X], thus overall N=12 optical elements. The optical properties which the optical elements A and A′ impress onto the light are herein the same, the same applies to the elements B and B′, C and C′, D and D′, E and E′ as well as F and F′. The distance between a given optical element A to F or A′ and F′, respectively, and the particular adjacent optical element is in each case of the same magnitude. Each of the two sets of six sequentially disposed elements herein covers an angular range of 2α, thus 180°; accordingly, the angle β between adjacent optical elements on the second circular shaped carrier is also of the same magnitude and is in each case 30°.

The second carrier 120 comprises a driver 121. The first carrier 110 comprises a receiver 111 which extends over an angular range of 150°, thus (N1−1/N1*2α) and into which the driver 121 engages such that the lateral edges 111a, 111b of the receiver 111 form each a limit stop for the driver 121. The cooperation of the driver 121 and the receiver 111 enable actuating the first carrier 110 and the second carrier 120 with only one motor and, nevertheless, setting any arbitrary combinations of optical elements of the first carrier 110 in the illumination channels and optical elements of the second carrier 120 in the viewing channels [sic: 40, 50] as will be explained below in conjunction with FIGS. 3a to 3m.

If the position of illumination channels [sic: 20,30] and viewing channels [40, 50] evident in FIG. 1 is taken into consideration, then when viewing FIG. 3a it is immediately obvious that a condition is depicted therein in which the optical elements A, A′ influence the illumination channels 20, 30 and the optical elements 1, 1′ influence the viewing channels 40, 50.

The clockwise rotation by 30° of the second carrier 120 illustrated in FIG. 3b does not change the position of the first carrier 110 such that the condition depicted in FIG. 3c results in which the optical elements B, B′ influence the illumination channels [sic: 20, 30], and the optical [elements] 1, 1′ influence the viewing channels [sic: 40, 50].

The renewed clockwise rotation by 30° of the second carrier 120, illustrated in FIG. 3d, again does not change the position of the first carrier 110 such that the condition shown in FIG. 3e results in which the optical elements C, C′ influence the illumination channels [sic: 20, 30] and the optical elements 1,1′ influence the viewing channels [sic: 40, 50].

a highly compact disposition of the optical elements is ensured.

A further clockwise rotation by 30° of the second carrier 120 illustrated in FIG. 3f still does not change the position of the first carrier 110 such that the condition results shown in FIG. 3g in which the optical elements D, D′ influence the illumination channels [sic: 20, 30] and the optical element [sic: elements] 1, 1′ influence the viewing channels [sic: 40, 50].

If the further clockwise rotation by 30°illustrated in FIG. 3h of the second carrier 120 is executed, this also does not change the position of the first carrier 110 such that the condition illustrated in FIG. 3i results in which the optical elements E, E′ influence the illumination channels [sic: 20, 30], and the optical elements 1, 1′ influence the viewing channels [sic: 40, 50].

After the clockwise rotation by 30° of the second carrier 120 illustrated in FIG. 3j nothing regarding the position of the first carrier 110 still has not changed, but in the condition depicted in FIG. 3k not only the optical elements F, F′ influence the illumination channels [sic: 20, 30] and the optical elements 1, 1′ influence the viewing channels [sic: 40, 50], but the driver 121 has been brought into contact with the limit stop 111b [sic] formed by the right edge [111a, 111b] [sic: 111b] of recess 111 such that a further clockwise rotation leads to a change of the position of the first carrier 110.

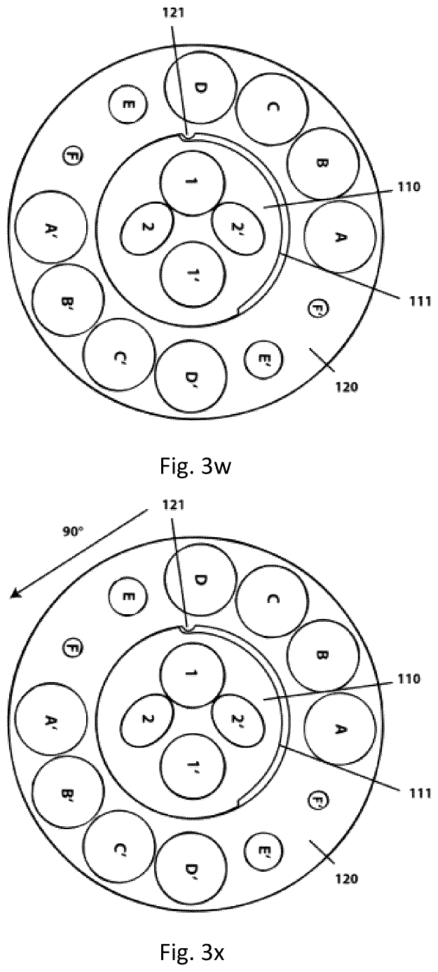

Since the next optical element 2, respectively 2′, of the set of sequentially disposed elements for the viewing channels 40, 50 follows at a distance of 90° from the optical elements 1, 1′ disposed until now in the viewing channel 40, 50, a clockwise rotation about 90° is executed to effect a switch, as is illustrated in FIG. 31. Correspondingly, when switching the changers [sic: 100] for optical elements is conveyed into a position in which the optical elements C′(!), C [sic: C, C′] influence the illumination channels [sic: 20, 30] and the optical elements 2, 2′ influence the viewing channels [sic: 40, 50].

It is herein noteworthy that in this position optical elements, those optical elements that do not belong to the particular set of N1 sequentially disposed optical elements, but rather are disposed such that they continue the set of N1 optical elements influence the illumination channels 20, 30. This also illustrates directly why it can be useful to continue this set of optical elements on one side or on both sides.

Since the driver 121 continues to be in contact with the limit stop 111b [sic] formed by the right edge [sic: 111b] of recess 111, for the setting of other optical properties of the light provided by the illumination 20, 30 for the illumination, while the optical elements 2, 2′, which influence the viewing channels 40, 50, an anticlockwise rotation must take place, as is shown in FIG. 3m.

It should be noted at this point that in the case of analogously constructed changers [sic: 100] for optical elements, in which more than two optical elements are disposed on the first carrier 110, the switching to the next optical element of the first carrier [sic: 110] would take place by a renewed clockwise rotation by the distance angle between the optical elements of the first carrier [sic: 110]; accordingly, the continuation of the set of N1 optical elements on the second carrier [sic: 120] must also have more optical elements.

After the rotation of the second carrier 120 by 30° against [sic:] [in the counterclockwise direction] as shown in FIG. 3n, the optical elements B′,B [sic] influence the illumination channels [sic: 20, 30], and the optical elements 2, 2′ influence the viewing channels [sic: 40, 50], as is shown in FIG. 30. The driver 121 is now also no longer in contact with the limit stop formed by the right edge 111b of the recess 111.

Further counterclockwise rotations of the second carrier [sic: 120] by 30°, depicted in FIGS. 3p, 3r, 3t and 3v, the optical elements A, A′; F, F′; E, E′; respectively D, D′ can now be placed into the illumination beam entry such that the configurations of the changer 100, depicted in FIGS. 3q, 3s, 3u and 3w, are set.

In the last described disposition, the driver 121 has been brought into contact with the limit stop 111a [sic] formed by the left edge [sic: 111a] of the recess 111, so that a further counterclockwise rotation leads to a change in the position of the first carrier 110 and, as FIG. 3x illustrates, the state of the changer 100 shown in FIG. 3a can be restored by a 90° counterclockwise rotation.

### LIST OF REFERENCE SYMBOLS

10 Optical instrument
20,30 Illumination channel
40,50 Viewing channel
100 Changer
110 First carrier
111 Receiver
111a,111b Lateral edge of the receiver
120 Second carrier
121 Driver
1, 1′ ,2, 2′, A, A′, B, B′,
C, C′, D, D′, E, E′, F, F′ Optical element
α, β Angle
R1, R2 Distance
X Center axis
[sic: N1, N, M, M1 Numbers, Sets of numbers]

1. Changer (100) for optical elements of an optical instrument (10), wherein the optical instrument (10) comprises at least one viewing channel (40, 50) and at least one illumination channel (20, 30),
wherein the changer (10) [sic: 100] comprises a first carrier (110) for optical elements which is supported rotatably about a center axis (X) and further comprises a second carrier (120) for optical elements which is supported rotably about the same center axis (X) as the first carrier (110),
wherein on the first carrier (110) a number M of optical elements for influencing light in the viewing channel (40, 50) or in the illumination channel (20, 30) comprises [sic: is disposed] which comprises a set of M1 sequentially disposed optical elements with which onto the light in the viewing channel (40, 50) or in the illumination channel (20, 30) M1 different properties can be impressed.
wherein on the second carrier (120) a number N optical elements for influencing light in the illumination channel (20, 30) or in the viewing channel (40, 50) comprises [sic: is disposed] which comprises a set of N1 sequentially disposed optical elements with which onto the light in the illumination channel (20, 30) or in the viewing channel (40, 50) N1 different properties can be impressed,
wherein the optical elements disposed on the first carrier (110) for optical elements are each disposed at a first distance (R1) from the center axis (X) such that the distance of optical elements adjacent to each other, at least for the M1 sequentially disposed [sic: optical] elements is equal such that a change between adjacently disposed optical elements can each be accomplished by rotation of the first carrier [sic: 110] about the same angle,
wherein the optical elements disposed on the second carrier (120) for optical elements are each disposed at a second distance (R2) from the center axis (X) such that the distance of these optical elements adjacently disposed with respect to one another, at least for the N1 sequentially disposed elements, is equal such that each change between adjacent optical elements can be accomplished by rotation of the second carrier [sic: 120] about the same angle,
wherein the second distance (R2) is greater than the first distance (R1),
wherein the first carrier (110) and the second carrier (120) are implemented such that they comprise openings or transparent regions for enabling the passage of light at those sites that are located in front or behind an optical elements of the particular other carrier when both optical elements are introduced effectively into the particular viewing channel [sic: 40, 50] or illumination channel [sic: 20, 30].

2. Changer (100) as in claim 1,
characterized in that the angle between two adjacent M optical elements of the first carrier (110) is α and that the N1 optical elements of a set of sequentially disposed optical elements on the second carrier (120) are disposed within an angular range of 2α.

3. Changer (100) as in claim 2,
characterized in that the first carrier (110) comprises a driver [sic: 121] and the second carrier (120) comprises a receiver [sic: 111] which extends at least over an angular range of (N1−1)/N1*2α and into which the driver [sic: 121] engages such that the lateral edges [sic: 111a, 111b] of the receiver [sic: 111] form each a limit stop for the driver [sic: 121].

4. Changer (100) as in claim 2,
characterized in that the second carrier (120) comprises a driver (121) and the first carrier (110) comprises a receiver (111) which extends at least over an angular range of (N1−1)/N1*2α and into which the driver (121) engages such that the lateral edges (111a, 111b) of the receiver (1119) [sic: 111] form a limit stop for the driver (121).

5. Changer (100) as in one of claims 1 to 4,
characterized in that N1>M1.

6. Changer (100) as in one of claims 1 to 5,
characterized in that that N≥N1*1.5 and that the N-N1 optical elements which do not belong to the set of N1 sequentially disposed optical elements are disposed such that they continue the set of N1 optical elements on one or both sides.

7. Changer (100) as in one of claims 1 to 6,
characterized in that N is a whole number multiple of N1 and/or that M is a whole number multiple of M1.

8. [sic] Changer (100) as in claim 7,
characterized in that N is a whole number multiple of N1 and/or that M is a whole number multiple of M1.

9. Optical instrument (10) with a changer (100) as in one of claims 1 to 8.

10. Optical instrument (10) as in claim 9.
characterized in that the optical instrument (10) comprises two viewing channels (40, 50) and two illumination channels (20, 30) and that the center axis (X) extends centrally between the viewing channels (40, 50) as well as also centrally between the illumination channels (20, 30) such that, on the one hand, optical elements of the first carrier (110) opposing one another simultaneously influence the light in the two viewing channels (40, 50) or in the two illumination channels (20, 30) and, on the other hand, optical elements of the second carrier (120) opposing one another simultaneously influence the light in the two illumination channels (20, 30) or in the two viewing channels (40, 50).

11. Optical instrument (10) as in one of claims 9 or 10,
characterized in that the changer (100) comprises the characteristics of claim 3 or the characteristics of claim 4 and that the optical instrument (10) comprises precisely one motor for actuating the optical changer (100).
